(19) United States
(12) Patent Application Publication
(10) Pub. No.: US 2009/0117305 A1
(43) Pub. Date: May 7, 2009

(54) Bundle of Sticky Notes and Sticky Note Supply Device

(75) Inventor: Hideki SAKANO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/207,305

(22) Filed: Sep. 9, 2008

(30) Foreign Application Priority Data
Nov. 6, 2007 (JP) 2007-288504

(51) Int. Cl. B32B 33/00; B65H 1/04; B65H 1/12; B65H 3/06

(52) U.S. Cl. 428/40.1; 221/40; 221/43; 221/46; 221/58

(57) ABSTRACT

A bundle of sticky notes that includes: a pile of sticky notes including a plurality of sticky notes whose one end portions are peelably adhered to one another; and a base member adhered to the pile of sticky notes via the lowermost sticky note. In the bundle, an outer periphery of the base member is partially protruded from the pile of sticky notes.

### CROSS-REFERENCE TO RELATED APPLICATION

This application claims, under 35 USC 119, priority of Japanese Application No. 2007-288504 filed Nov. 6, 2007.

### BACKGROUND

1. Technical Field

The present invention relates to a bundle of sticky notes made of a pile of sticky notes including a plurality of sticky notes and a base member to which the pile of sticky notes is adhered, and a sticky note supply device using the bundle of sticky notes.

2. Related Art

On the market, there has been a bundle of sticky notes in which a pile of sticky notes including a plurality of sticky notes each having an adhesive section in a part thereof and a base member of the same size as the sticky note are combined.

An existing sticky note printer using such a bundle of sticky notes (sticky note supply device) includes a sticky note holder, a pickup roller (sticky note peeling-off means), a sticky note feeding mechanism, and a sticky note printing mechanism (printing means). The sticky note holder fixedly holds the sticky note located on the top of the bundle at its end portions in the long-side direction. The pickup roller peels off the sticky notes one by one from the top of the bundle, the sticky note feeding mechanism feeds, for printing, the sticky notes peeled off by the pickup roller, and the sticky note printing mechanism executes a printing process to the sticky notes from a free end side thereof. An example of the related art includes Patent Document 1 (JP-A-2006-175878).

With such an existing bundle of sticky notes, a user holds the sides of the bundle and peel off the sticky note on the top of the bundle. However, since there is no significant difference between the base member and the sticky notes in terms of stiffness, there is a problem that when the sticky notes decrease in number, the user's fingers likely hold the sticky note to be peeled off, thereby causing difficulty in peeling off of the sticky note.

The sticky note supply device using such a bundle of sticky notes is of a configuration that the bundle is pressed down at both end portions thereof, i.e., the adhesive section side and the free end side, using retention lugs provided at upper front and rear end portions of the sticky note holder. Such a configuration makes peeling (peeling-off) of the sticky note unstable. That is, when the sticky note on the top of the bundle is picked up from the free end side thereof and pulled further for peeling it off, because the adhesive section side of the sticky note is being pressed by the retention lugs, the sticky note is not angled well enough for peeling, whereby a large force is required for peeling off the sticky note. Moreover, when the sticky notes decrease in number, the bundle is distorted in its entirety at the time of peeling off, thereby causing a problem that the bundle falls off from the sticky note holder.

### SUMMARY

An advantage of some aspects of the invention is to provide a bundle of sticky notes that allows easy and stable peeling of sticky notes, and a sticky note supply device using such a bundle.

A first aspect of the invention is directed to a bundle of sticky notes that includes: a pile of sticky notes including a plurality of sticky notes whose one end portions are peelably adhered to one another; and a base member adhered to the pile of sticky notes via the lowermost sticky notes. In the bundle, an outer periphery of the base member partially protrudes from the pile of sticky notes.

With such a configuration, the base member is formed thick, and has a hand-holding portion protruding from the pile of sticky notes, thereby allowing a user to grip the bundle of sticky notes without putting his or her finger on the pile of sticky notes. This favorably allows a user to peel off, with reliability and stability, the sticky note one by one from the bundle.

In the configuration, preferably, the pile of sticky notes and the base member are each formed in a rectangular shape in a planar view, and with respect to a pile of sticky notes, two width-direction sides of the base member look protruding.

With such a configuration, a user can hold with ease a bundle of sticky notes by the two sides protruding from a pile of sticky notes in the width direction, thereby being able to peel off the sticky note one by one from a bundle with good efficiency.

A second aspect of the invention is directed to a sticky note supply device that houses therein a bundle of sticky notes configured by a pile of sticky notes including a plurality of sticky notes whose one end portions are each adhered to be able to be peeled off from the remaining, and a base member adhered with the pile of sticky notes via one of the sticky notes located at the bottom, and allows peeling off of the sticky note from the pile thereof. The device includes: a sticky note holder that detachably holds the bundle of sticky notes; and a chassis that houses therein the sticky note holder, and is provided with an aperture section for peeling off of the sticky note. The sticky note holder includes a base member retention section that holds down the base member against a force of peeling off the sticky note, and the base member includes a latch section that is latched by the base member retention section in a peel-off direction of the sticky note.

With such a configuration, the latch section of the thick base member is latched by the base member retention section of the sticky note holder, whereby the sticky note holder can retain a bundle of sticky notes. That is, unlike the previous technologies of pressing down, from above using the retention lugs, a pile of sticky notes at both end portions in the long-side direction, the bundle of sticky notes can be retained while a user holding the base member. With this configuration, a pile of sticky notes is not pressed down from above so that the bundle can be retained well while the sticky note is being peeled off. This accordingly enables a user to peel off the sticky note with ease, and even if the bundle gets low, the base member is not misaligned due to a force of peeling off the sticky note so that the bundle remains retained by the sticky note holder. As such, the sticky notes can be peeled off with stability until the last piece of the bundle.

A third aspect of the invention is directed to a sticky note supply device that includes: a sticky note holder that detachably holds a bundle of sticky notes configured by a pile of sticky notes including a plurality of sticky notes whose one end portions are each adhered to be able to be peeled off from the remaining, and a base member adhered with the pile of sticky notes via one of the sticky notes located at the bottom; a sticky note peel-off unit that is disposed opposed to the bundle of sticky notes retained by the sticky note holder, and peels off and forwards the sticky note one by one starting from the sticky note on the top of the pile; and a chassis that houses therein the sticky note holder and the sticky note peel-off unit. In the device, the sticky note holder includes a base member retention section that holds down the base member against a force of peeling off the sticky note, and the base member includes a latch section that is latched by the base member retention section in a peel-off direction of the sticky note.

With such a configuration, the latch section of the thick base member is latched by the base member retention section of the sticky note holder, whereby the sticky note holder can retain a bundle of sticky notes. That is, unlike the previous technologies of pressing down, from above using the retention lugs, a pile of sticky notes at both end portions in the long-side direction, the bundle of sticky notes can be retained while a user holding the base member. With this configuration, a pile of sticky notes is not pressed down from above so that the bundle can be retained well while the sticky note is being peeled off. This accordingly leads to easy peeling of the sticky note by the sticky note peel-off unit, i.e., the sticky note can be peeled off one by one easily with a small force. Moreover, even if the bundle gets low, the base member is not misaligned due to a force of peeling off the sticky note so that the bundle remains retained by the sticky note holder. As such, the sticky note can be peeled off with reliability and stability until the last piece of the bundle.

In this configuration, preferably, a cassette is further provided for retaining the sticky note holder in an upward-biased state, and is detachably inserted into the chassis.

If this is the configuration, a bundle of sticky notes can be detachably loaded at any predetermined position of the chassis via a cassette. This means that a user loads a bundle of sticky notes to the cassette removed from the chassis, thereby easing the loading of the bundle to the sticky note holder retained by the cassette. Herein, preferably, the sticky note holder, i.e., a bundle of sticky notes, is biased upward in advance based on the cassette using a spring or others.

In this configuration, preferably, in the base member, two width-direction sides each have an extra width section that is a protrusion from a pile of sticky notes, the latch section of the base member is configured by the extra width section, and the base member retention section of the sticky note holder is configured by a dovetail groove formed to a side portion with which each of the extra width sections is slidably engaged and is latched in the peel-off direction.

If this is the configuration, a bundle of sticky notes is moved to slide for insertion into a dovetail groove on the side portion via the extra width section, i.e., latch section, thereby easing the loading of the bundle of sticky notes to the sticky note holder. Moreover, the base member can be pressed down by the dovetail groove on the side portion, thereby preventing the bundle from being lifted up in its entirety when the sticky note is peeled off from the bundle.

In this configuration, preferably, one of the extra width sections is formed with a cut-out portion as a result of cutting out a tip end portion thereof in a sliding direction, and the sticky note holder corresponding to the extra width section is formed with an engagement portion for engagement with the cut-out portion.

If this is the configuration, by the cut-out portion of one of the extra width sections and the engagement portion of the sticky note holder corresponding thereto, a bundle of sticky notes can be controlled in direction of sticky note loading with respect to the sticky note holder. That is, the adhesive section, i.e., glued section, of the bundle of sticky notes is restrictively controlled in orientation, i.e., whether it is located at the head or tail in the direction of slide loading. This favorably prevents a user from erroneously loading a bundle of sticky notes to the sticky note holder in the wrong direction.

In this configuration, preferably, in the base member, a side closer to an adhesive section of each of the sticky notes has an extra length section that is a protrusion from the pile of sticky notes, and an aperture section is formed on a free end side, the latch section of the base member is configured by the extra length section and the aperture section, and the base member retention section of the sticky note holder is configured by a dovetail groove formed on the adhesive-end side for latching of the extra length section in the peel-off direction, and a push-in protrusion section into which the aperture section is pushed.

Similarly, in this configuration, preferably, in the base member, a side closer to an adhesive section of each of the sticky notes has an extra length section that is a protrusion from the pile of sticky notes, and a notch section is formed on a free end side, the latch section of the base member is configured by the extra length section and the notch section, and the base member retention section of the sticky note holder is configured by a dovetail groove formed on the adhesive section side for latching of the extra length section in the peel-off direction, and a push-in protrusion section into which the notch section is pushed.

With such configurations, the aperture portion or the notch portion of a bundle of sticky notes is pushed from above into the push-in protrusion section of the sticky note holder while the extra length section of the base member being latched by the dovetail groove on the adhesive side, thereby solidly loading the bundle to the sticky note holder with ease. That is, for peeling off the sticky note, the bundle is never lifted up because of the dovetail groove on the adhesive side and the push-in protrusion section of the sticky note holder. Herein, the aperture section or the notch section is preferably disposed with a slight displacement from the center of the base member, and if this is the configuration, the bundle of sticky notes can be controlled in direction of sticky note loading.

In this configuration, preferably, in the base member, a side closer to an adhesive section of each of the sticky notes has a first extra length section that is a protrusion from the pile of sticky notes, and a free end side has a second extra length section that is a protrusion from the pile of sticky notes, the latch section of the base member is configured by the first and second extra length sections, the base member retention section of the sticky note holder is configured by an adhesive-end-side hook section by which the first extra length section is lathed in the peel-off direction, and a free-end-side hook section by which the second extra length section is latched in the peel-off direction, and either the adhesive-end-side hook section or the free-end-side hook section is configured to be able to move between a latch position and a latch release position.

With such a configuration, by the adhesive-end-side hook section and the free-end-side hook section of the peel-and-stick holder, the adhesive section side and the free end side of the base member can be held down. Moreover, with the configuration of moving the free-end-side hook section at the latch release position, and moving again the free-end-side hook section this time to the latch position after the first extra length section is latched by the adhesive-end-side hook section, the loading of a bundle of sticky notes to the sticky note holder is eased with such a simple operation.

In this configuration, preferably, in the base member, a side closer to an adhesive section of each of the sticky notes has a first extra length section that is a protrusion from the pile of sticky notes, and a free end side has a second extra length section that is a protrusion from the pile of sticky notes, the latch section of the base member is configured by the first and second extra length sections, the base member retention section of the sticky note holder is configured by an adhesive-end-side sawtooth-like abutment section digging into an end surface of the first extra length section, and a free-end-side sawtooth-like abutment section digging into an end surface of the second extra length section, and either the adhesive-end-side abutment section or the free-end-side abutment section is configured to be able to move between an abutment position and an abutment free position.

With such a configuration, the adhesive-end-side abutment section and the free-end-side abutment section are both made to dig into the base member, thereby holding down both the adhesive-section side and the free-end side of the base member. Moreover, by moving the free-end-side abutment section to the abutment free position, and by moving the free-end-side abutment section to the abutment position after making the first extra length section abut the adhesive-end-side abutment section, the bundle of sticky notes can be detachably attached to the sticky note holder with such a simple operation.

In this configuration, preferably, a printing unit is further provided for printing a sticky note by being disposed opposing the sticky note that is peeled off and forwarded by the sticky note peel-off unit.

With such a configuration, favorably provided is a sticky note supply device that can apply a printing process to a sticky note peeled off one by one from the bundle.

### BRIEF DESCRIPTION OF THE DRAWINGS

The invention will be described with reference to the accompanying drawings, wherein like numbers reference like elements.

FIG. 1 is a perspective view of a bundle of sticky notes.

FIG. 2 is an external perspective view of a sticky note printer.

FIG. 3 is a cross-sectional view of the sticky note printer.

FIGS. 4A and 4B are exploded perspective views of an area around a sticky note cassette.

FIG. 5 is a schematic diagram of a control device.

FIGS. 6A to GE are diagrams for illustrating a series of process operations of the sticky note printer.

FIGS. 7A to 7D are cross-sectional views of an area around a sticky note holder of a first modified example, and that of a second modified example.

FIGS. 8A to 8D are cross-sectional views of an area around a sticky note holder of a third modified example.

FIGS. 9A and 9B are cross-sectional views of an area around a sticky note holder of a fourth modified example.

FIGS. 10A and 10B are external perspective view of a sticky note dispenser of a second embodiment.

### DESCRIPTION OF EXEMPLARY EMBODIMENTS

In the below, by referring to the accompanying drawings, described is a sticky note printer using a sticky note supply device in a first embodiment of the invention. This sticky note supply device is connected to a personal computer (PC) that is not shown, and is under the control of the PC, i.e., the sticky note supply device ejects, to the outside of the device, sticky notes that have been printed after being peeled off one by one from a bundle loaded inside of the device case, or sticky notes that have been peeled off but not printed, i.e., unprinted sticky notes.

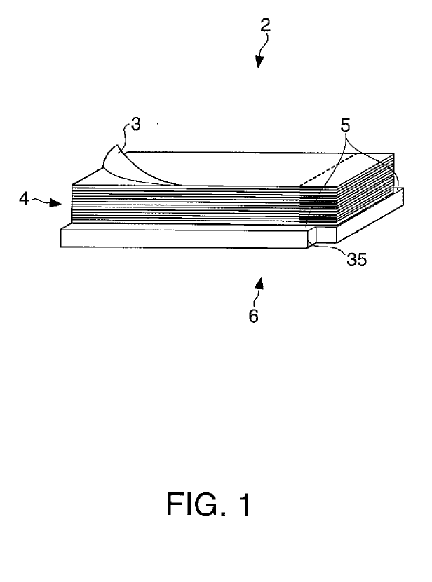

By referring to FIG. 1, described first is a bundle of sticky notes 2, which is a supply target of a sticky note printer 1. The bundle of sticky notes 2 is shaped like a rectangle, for example, and is configured by a pile of sticky notes 4, and a base member 6. The pile of sticky notes 4 includes a plurality of sticky notes 3 each having an adhesive section, i.e., glued section, at one end portion on the underside, and the base member 6 is formed larger than the pile of sticky notes 4. The base member 6 is made of a material having rigidity, e.g., cardboard, acrylic plate, and resin. In the base member 6, an outer periphery is partially protruded from the pile of sticky notes 4, e.g., two sides of the sticky note 3 in the width direction (right and left sides thereof in a direction from which the sticky note holder is inserted) The resulting protrusions serve as a pair of extra width sections, i.e., latch sections, 5 to be gripped by a user to peel off the sticky note 3. The pile of sticky notes 4 is fixedly adhered to the base member 6 via the adhesive section of the sticky note 3 at the bottom, whereby the bundle of sticky notes 2 is configured. The extra width sections 5 are each of a predetermined width, and are extending in the length direction of the bundle of sticky notes 2. At the tip end portion of one of the extra width sections 5, i.e., the one located at the front in the drawing, is formed with a notch section, i.e., cut-out portion, 35 for engagement with a protrusion section, e.g., engagement portion, 36 formed to a sticky note holder 31 that will be described later.

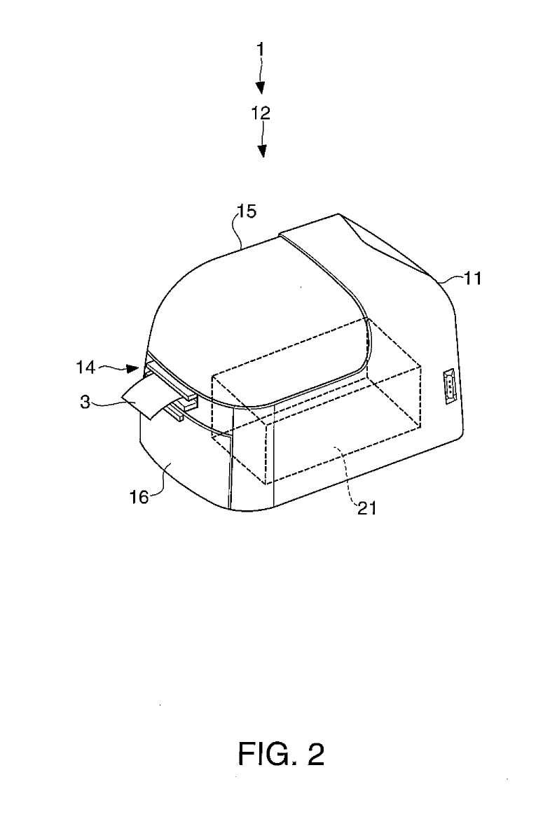

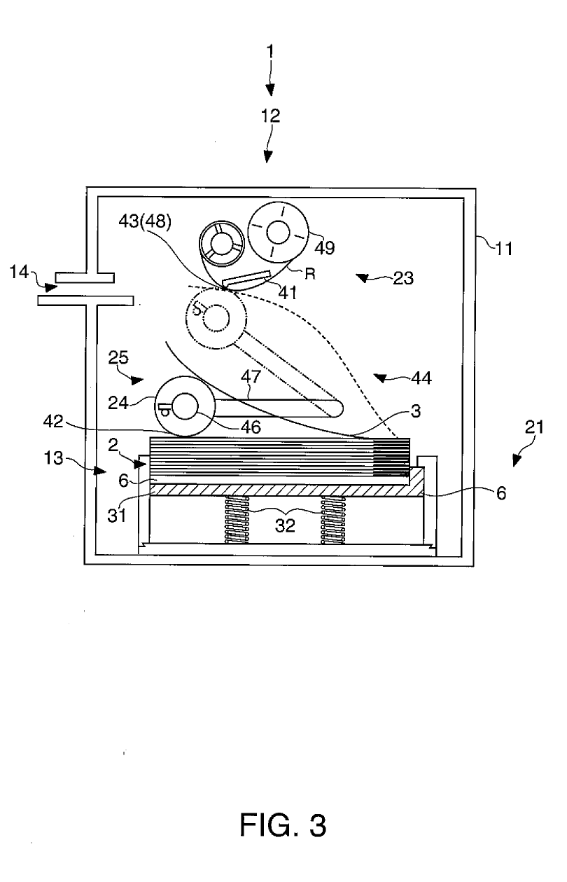

As shown in FIGS. 2 and 3, the sticky note printer 1 is configured to include a device body 12, a sticky note cassette 13, and a ribbon cartridge. The device body 12 serves as an outer case with a device case 11 being a chassis. The sticky note cassette 13 is installed to the device body 12 with the bundle of sticky notes 2 loaded therein. The ribbon cartridge carries therein an ink ribbon R that is not shown. With respect to the bundle of sticky notes 2 loaded inside of the device body 12 via the sticky note cassette 13, the internal components of the device body 12 (will be described later) are opposing. With such a configuration, the sticky note printer 1 prints data acquired from a personal computer via the ink ribbon R while peeling off and forwarding the sticky notes 3 sequentially from the one on the top of the bundle. The printing result is forwarded to a sticky note ejection slot 14 formed to the device case 11 for ejection therefrom.

The device case 11 is formed small in its entirety, and on the upper surface thereof, an open/close lid 15 is attached for use of device maintenance and loading of the ribbon cartridge. The device case 11 is also formed with, at the center portion of the front surface, the sticky note ejection slot 14 shaped like a slit for forwarding any printed sticky note 3 to outside of the device case 11. On the lower front surface of the device case 11, a cassette guide aperture 16 is formed for loading of the sticky note cassette 13 shaped like a drawer. Note that, in the below, the side of the sticky note ejection slot 14 is referred to as “front”, and the side opposite thereto is referred to as “rear”. Accordingly, the free end side of the loaded bundle of sticky notes 2 is the “front”, and the adhesive section side thereof is the “rear”.

As shown in FIG. 3, the device body 12 is configured to include a cassette loading section 21, a sticky note printing mechanism, i.e., printing unit, 23, a sticky note peel-off mechanism, i.e., sticky note peel-off unit, 25, and the device case 11. The cassette loading section 21 is located on the lower side of the device body 12, and is loaded with the sticky note cassette 13 detachably carrying therein the bundle of sticky notes 2. The sticky note printing mechanism 23 is located above the sticky note cassette 13 (the bundle of sticky note 2) loaded to the cassette loading section 21, and is opposed to the sticky note cassette 3 for executing a printing process to the sticky note 3. The sticky note peel-off mechanism 25 rubs and picks up the sticky note 3 on the top of the bundle of sticky notes 2 using a pickup roller 24 that will be described later, and then peels off and forwards the sticky note 3 to the sticky note printing mechanism 23 for ejection from the sticky note ejection slot 14. The device case 11 houses therein all of these components. Herein, the pickup roller 24 of the sticky note peel-off mechanism 25 serves also as a platen roller of the sticky note printing mechanism 23.

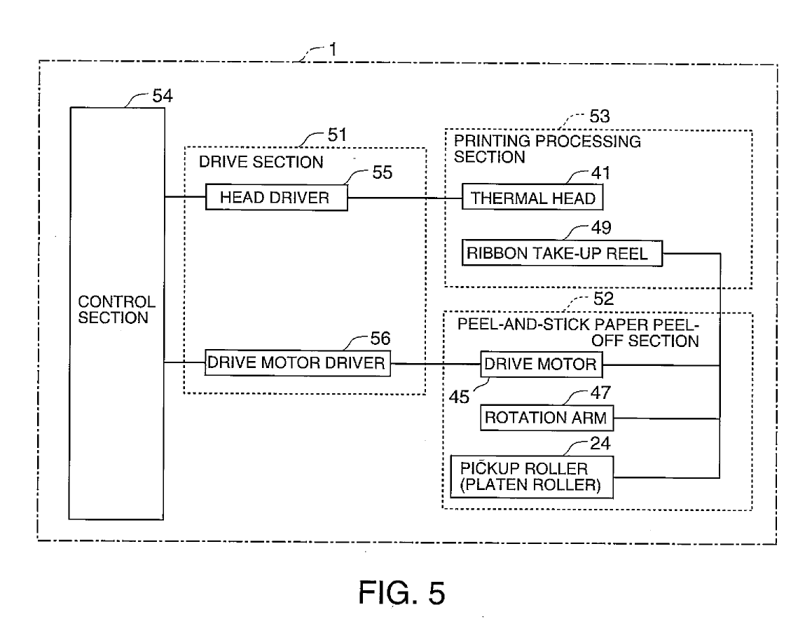

The sticky note peel-off mechanism 25 is provided for peeling off and forwarding the sticky note 3 on the top of the bundle of sticky notes 2, and is configured to include the pickup roller 24, a roller moving unit 44, a drive motor 45 (see FIG. 5), and a reduction gear train 46. The pickup roller 24 is rotated and comes in contact with the sticky note 3 on the top of the bundle of sticky notes 2, and then rubs and picks up the sticky note 3. The pickup roller 24 then nips the picked-up sticky note 3 together with a thermal head 41 (will be described later), and forwards the sticky note 3 through rotation. The roller moving unit 44 moves the pickup roller 24 between a rub-and-pick-up position 42 and a printing position 43 where the sticky note 3 is printed. The drive motor 45 is a DC (Direct Current) motor, and serves as a drive source for both the pickup roller 24 and the roller moving unit 44. The reduction gear train 46 transmits the drive force of the drive motor 45 to both the pickup roller 24 and the roller moving unit 44.

At the rub-and-pick-up position 42, when the pickup roller 24 rubs and picks up the sticky note 3 and then comes in contact with the underside of the picked-up sticky note 3 on the free end side, the pickup roller 24 is moved by the roller moving unit 44 to a nip position 48 via a rotation arm 47. At the nip position 48, the pickup roller 24 works together with the thermal head 41 to forward, through rotation, the sticky note 3 while peeling off the sticky note 3 from the bundle of sticky notes 2.

The sticky note printing mechanism 23 is configured to include the thermal head 41, and a ribbon take-up mechanism (not shown). The thermal head 41 is disposed in the vicinity of the sticky note ejection slot 14, and prints any peeled-off sticky note 3. The ribbon take-up mechanism serves to take up the ink ribbon R of any attached ribbon cartridge. The ribbon cartridge is configured to include a ribbon dispenser reel, a ribbon take-up reel 49, and a cartridge case (not shown). The ribbon dispenser reel is wound with the ink ribbon R for easy dispensing, and the ribbon take-up reel 49 takes up the ink ribbon R. The cartridge case houses therein the ribbon dispenser reel and the ribbon take-up reel 49 to be able to freely rotate. When the pickup roller 24 is moved to the printing position 43, the ribbon take-up mechanism is coupled to the above-described reduction gear train 46 to receive the power from the drive motor 45, and in synchronization with the feeding of the sticky note 3, starts taking up the ink ribbon R.

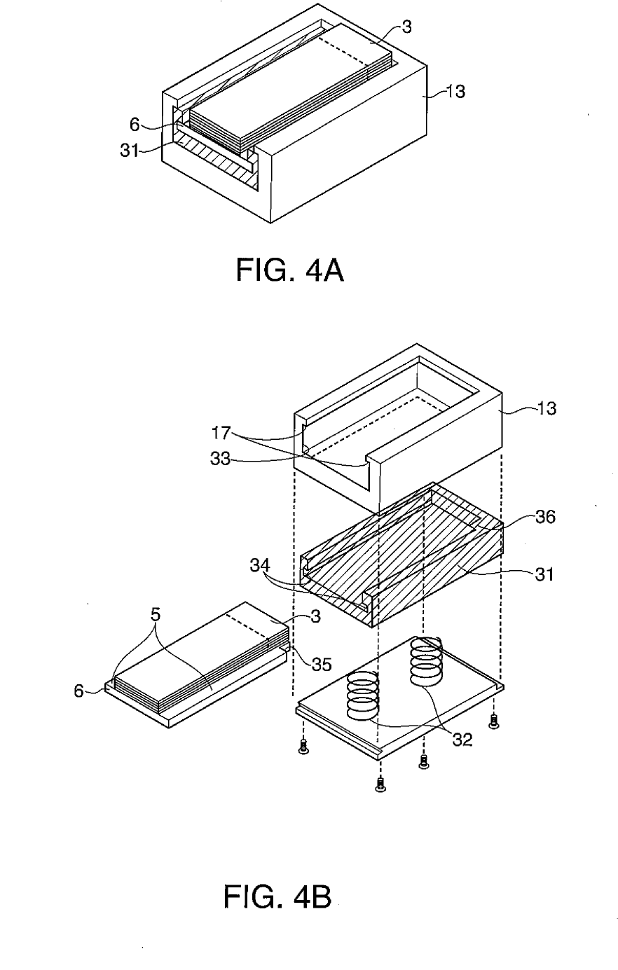

As shown in FIGS. 4A and 4B, the sticky note cassette 13 is shaped like a box with the upper surface being left open, and is provided therein with the sticky note holder 31 and two coil springs 32. The sticky note holder 31 holds therein the bundle of sticky notes 2, and the coil springs 32 bias upward the sticky note holder 31. These two coil springs 32 are disposed in the fore-and-aft direction with a space therebetween, and serve to bias upward the sticky note holder 31, i.e., the bundle of sticky notes 2, based on the bottom surface of the sticky note cassette 13. The sticky note cassette 13 is formed with, at the upper end portion, a restriction section 17 for restricting the move-up position of the sticky note holder 31 being under bias of the two coil springs 32. At the front end portion of the sticky note cassette 13, a notch aperture 33 is formed for moving to slide the bundle of sticky notes 2 into the sticky note holder 31 for loading.

The sticky note holder 31 serves to keep the bundle of sticky notes 2 in a horizontal position via the base member 6, and is shaped like a tray with no front wall. The inner side walls of the sticky note holder 31 are respectively formed with a pair of dovetail grooves, i.e., base member retention sections, 34 linked to the bottom surface. For loading of the bundle of sticky notes 2 to the sticky note holder 31, a pair of extra width sections 5 of the base member 6 are positioned to the dovetail grooves 34 formed on the side portions, and the bundle of sticky notes 2 is moved to slide from the notch aperture 33. For unloading the bundle of sticky notes 2, the process operations are followed in reverse order. When the pickup roller 24 comes in contact, with some pressure, from above with the bundle of sticky notes 2 loaded to the sticky note holder 31, the bundle of sticky notes 2 and the sticky note holder 31 are both moved down against the force of the two coil springs 32, thereby accepting the pressure of the pickup roller 24.

On one side of the sticky note holder, i.e., front side of the drawing, the protrusion section 36 is formed for engagement with the notch section 35 of the base member 6. In this configuration, the notch section 35 of the base member 6 is positioned to the protrusion section 36 of the sticky note holder 31, and then the bundle of sticky notes 2 is moved to slide into the sticky note holder 31 for loading. As a result, the notch section 35 and the protrusion section 36 are meshed together, and thus the bundle of sticky notes 2 can be completely loaded, and the free end of the bundle of sticky notes 2 is aligned with the front end of the sticky note holder 31. On the other hand, when the bundle of sticky notes 2 is moved to slide into the sticky note holder 31 for loading with no positioning between the notch section 35 of the base member 6 and the protrusion section 36 of the sticky note holder 31, the bundle of sticky notes 2 is not aligned with the front side of the sticky note holder 31, thereby resulting in incomplete sticky note loading. This makes a user aware of the wrong loading direction of the bundle of sticky notes 2 so that any possible loading failure can be prevented for the bundle of sticky notes 2.

By referring to FIG. 5, described next is the configuration of a control system of the sticky note printer 1. The sticky note printer 1 is configured to include a drive section 51, a sticky note peel-off section 52, a printing processing section 53, and a control section 54. The control section 54 is connected to the other components in the printer 1, and controls over the sticky note printer 1. The drive section 51 is configured to include a head driver 55, and a drive motor driver 56. The head driver 55 controls the driving of the thermal head 41 of the printing processing section 53. The drive motor driver 56 controls the driving of the ribbon take-up reel 49 of the printing processing section 53, and also controls the driving of the pickup roller 24 and the rotation arm 47 of the sticky note peel-off section 52.

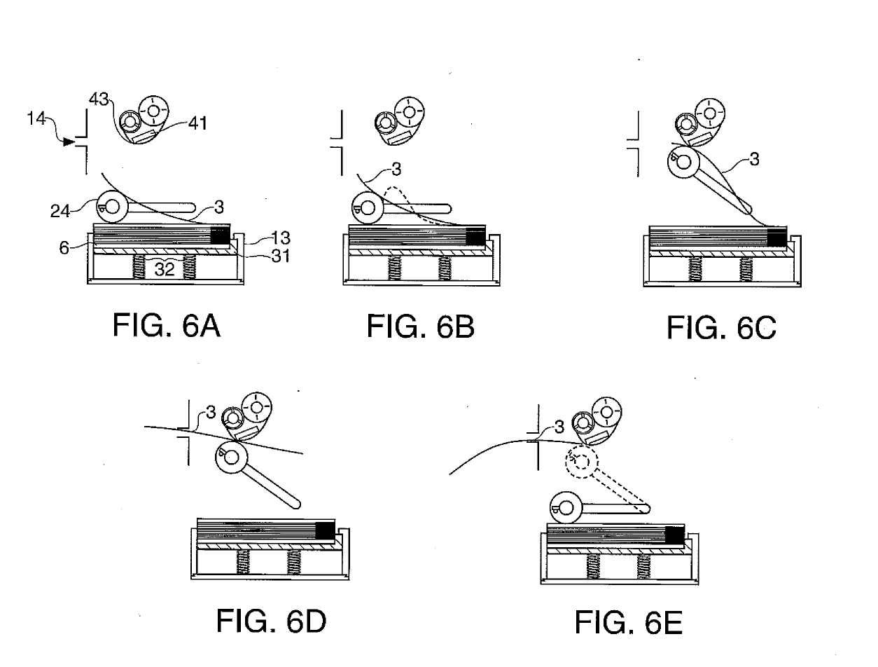

By referring to FIGS. 6A to 6E, described next is a series of process operations before ejection of the sticky note 3 after it is rubbed and picked up from the bundle of sticky notes 2. In the printing standby state, the pickup roller 24 is abutting the side closer to the free end from the middle of the sticky note 3 on the top of the loaded bundle of sticky notes 2 (see FIG. 6A). When a user issues a command of starting a printing job, the drive motor 45 responsively drives so that the pickup roller 24 starts rotating and picking up the sticky note 3. That is, by the pickup roller 24 being in the rotation movement while abutting the sticky note 3 on the top, the middle portion of the sticky note in the longitudinal direction gradually starts sagging as if being curved upward (see FIG. 6B).

Immediately after the free end of the sticky note 3 being lifted upward as such passes through below the pickup roller 24, the sticky note 3 is popped up above the pickup roller 24 due to the rotation of the pickup roller 24 so that the free end portion of the sticky note 3 is positioned on the pickup roller 24 due to the rigidity of the sticky note 3 (see FIG. 6B). The pickup roller 24 carrying thereon the sticky note 3 as such keeps rotating, and is moved to the printing position based on the base end portion thereof. When reaching the printing position 43, the sticky note 3 is nipped by the pickup roller 24 and the thermal head 41. This as a trigger, feeding of the ink ribbon R is started (see FIG. 6C).

The pickup roller 24 facing the printing position 43 as such works together with the thermal head 41 to peel off the nipped sticky note 3 from the bundle of sticky notes 2, and directs the sticky note 3, from the free end side thereof, toward the sticky note ejection slot 14. At the same time, the sticky note 3 is printed on the surface from the free end side thereof (see FIG. 6D). After the adhesive-end side of the sticky note 3 passes through the printing position, and when the printed sticky note 3 is ejected from the sticky note ejection slot 14, the pickup roller 24 responsively stops its rotation, and is moved to the rub-and-pick-up position 42 (see FIG. 6E).

As described above, with the sticky note printer 1 of this embodiment, the bundle of sticky notes 2 is fixed to the base member 6 via the extra width sections 5 thereof, thereby being able to be peeled off from the bundle of sticky notes 2 only with a force of peeling off the sticky notes 3 on the top and therebelow. Moreover, because the bundle of sticky notes 2 is never misaligned in its entirety, the bundle of sticky notes 2 will never fall off from the sticky note holder 31 so that the sticky note 3 can be peeled off from the bundle of sticky notes 2 without fail.

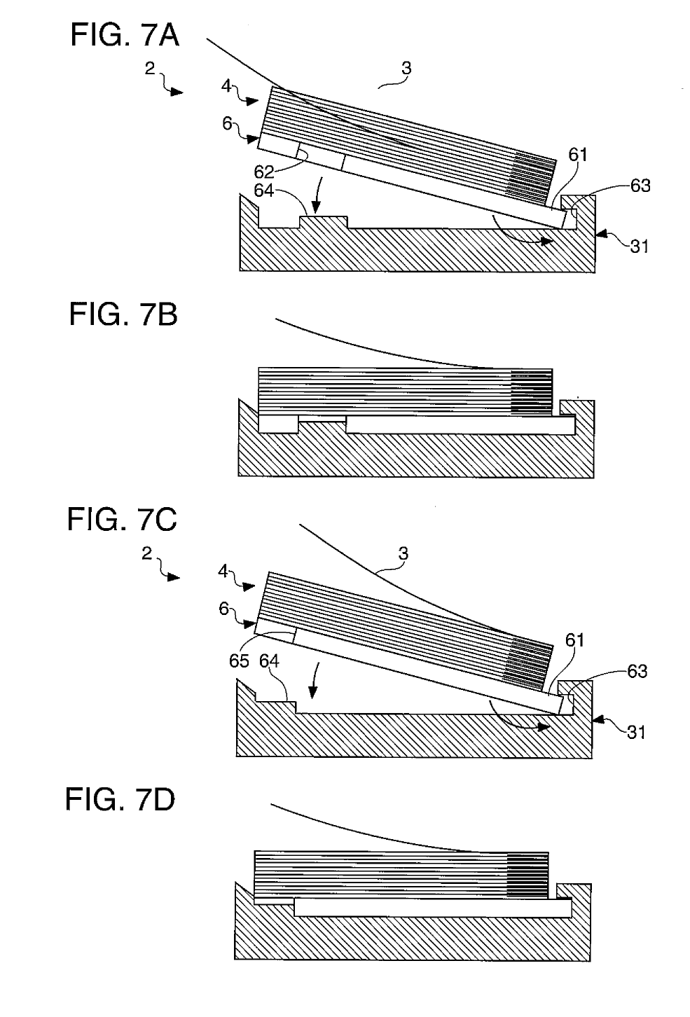

By referring to FIGS. 7A to 7D, described next is the configuration of an area around the sticky note holder 31 in a first modified example of the first embodiment. Herein, only any difference from the first embodiment will be described.

In this first modified example, the base member 6 of the bundle of sticky notes 2 is configured to include an extra length section 61, and an aperture section 62. The extra length section is a protrusion of the side closer to the adhesive section, i.e., rear end side, from the pile of sticky notes 4. The aperture section 62 is formed on the free end side of the base member 6 with the shape of a circle. The sticky note holder 31 is formed with a dovetail groove 63 on the adhesion side, and a push-in protrusion section 64 (see FIGS. 7A to 7D). The dovetail groove 63 is provided for latching the extra length section 61 in the peel-off direction, and the push-in protrusion section 64 is so shaped as to be complementary with the aperture section 62, i.e., circle. The front end portion of the sticky note 31 is a sloped surface for use to guide the bundle of sticky notes 2 for loading.

That is, for loading of the bundle of sticky notes 2 to the sticky note holder 31, the extra length section 61 is snapped into the dovetail groove 63 on the adhesion side, and the push-in protrusion section 64 is positioned to the aperture section 62 (see FIG. 7A). Thereafter, the bundle of sticky notes 2 is pushed into the side of the sticky note holder 31 with the guide of the sloped surface so that the bundle of sticky notes 2 is loaded (see FIG. 7B). As such, the bundle of sticky notes 2 is loaded flat to the sticky note holder 31. Also in this case, the bundle of sticky notes 2 is loaded to the sticky note holder 31 not to move, and thus the bundle of sticky notes 2 will never be lifted up when the sticky note 3 is peeled off.

Described next is the configuration of an area around the sticky note holder 31 in a second modified example of the first embodiment. In this second modified example, the difference from the first modified example lies only in that the base member 6 of the bundle of sticky notes 2 is formed with a notch section 65 as an alternative to the aperture section 62 described above. The notch section 65 is formed by squarely cutting out the front center portion of the base member 6 from the front, and corresponding thereto, the sticky note holder 31 is formed with the push-in protrusion section 64 shaped complementary with the notch section 65, i.e., square. That is, for loading of the bundle of sticky notes 2 to the sticky note holder 31, the extra length section 61 is snapped into the dovetail groove 63 formed on the adhesion side, and the push-in protrusion section 64 is positioned to the notch section 65 (see FIG. 7C). Thereafter, the bundle of sticky notes 2 is pushed into the holder 31 with the guide of the sloped surface (see FIG. 7D). This accordingly load the bundle of sticky notes 2 to the sticky note holder 31 not to move in the vertical direction, and the bundle of sticky notes 2 will never be lifted up when the sticky note 3 is peeled off.

With such a configuration, by pushing the extra length section 61 into the adhesion-side dovetail groove 63, and by pushing the bundle of sticky notes 2 from above, the bundle of sticky notes 2 can be loaded to the sticky note holder 31 with ease. Moreover, because the loading direction can be controllably restricted, a user can be prevented from any possible erroneous sticky note loading. Alternatively, the outer peripheral surface of the push-in protrusion section 64 may be formed like a sawtooth, i.e., may be serrated, or the push-in protrusion section 64 may be shaped like a star, and during push-in of the sticky note, the push-in protrusion section 64 may be made to dig into the aperture section 62 or the notch section 65 (not shown).

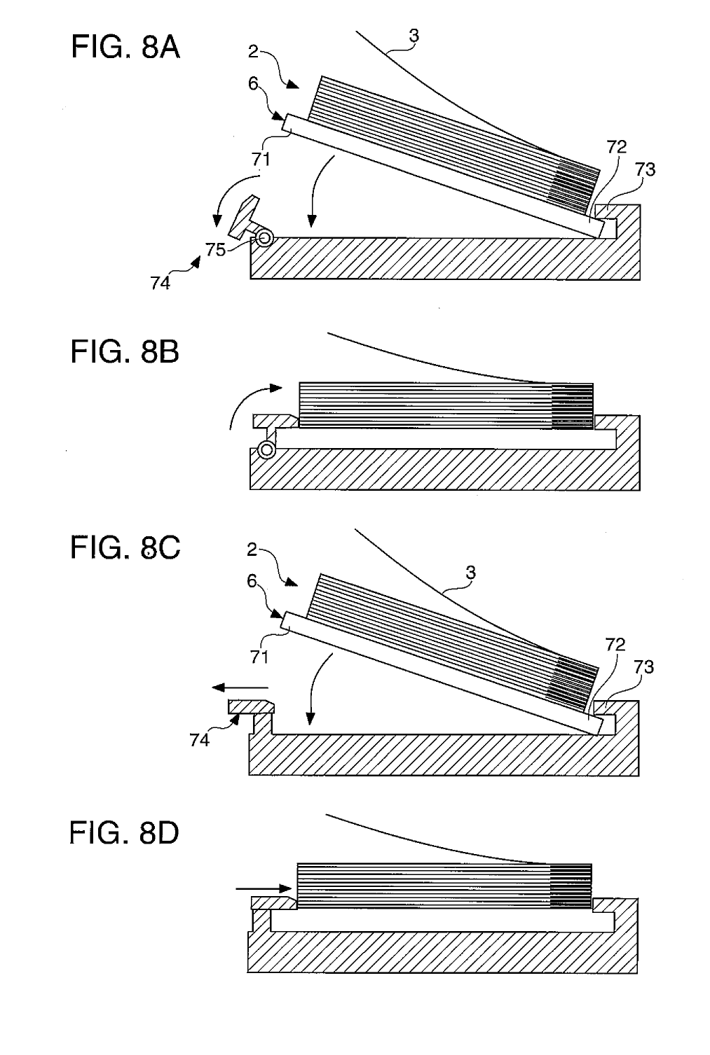

By referring to FIGS. 8A to 8D, described next is the configuration of an area around the sticky note holder 31 in a third modified example of the first embodiment. In this third modified example, in the base member 6 of the bundle of sticky notes 2, two sides in the length direction, i.e., front and rear sides thereof in a direction from which the sticky note holder is inserted, are protruded from the pile of sticky notes 4, and the resulting protrusions serve as front and rear extra length sections 71 and 72, i e., first and second extra length sections. At the front and rear end portions of the sticky note holder 31, an adhesive-end-side hook section 73 and a free-end-side hook section 74 are restrictively formed for latching of the extra length sections 71 and 72 in the peel-off direction.

The adhesive-end-side hook section 73 extends fully to the width of the sticky note holder 31, and the free-end-side hook section 74 is disposed at the center portion of the sticky note holder 31 in the width direction. The free-end-side hook section 74 is so shaped that the cross section thereof looks like a letter “T”, and is attached to the front end portion of the sticky note holder 31 to be able to freely rotate. Although not shown, a rotation shaft 75 of the free-end-side hook section 74 is incorporated with a twisted coil spring, and against the force of this coil spring, the free-end-side hook section 74 is tilted toward the outside, thereby loading the bundle of sticky notes 2 to the sticky note holder 31.

That is, the free-end-side hook section 74 is rotated toward the outside (front), i.e., latch release position, and the extra length section 72 on the rear side is snapped into the adhesive-end-side hook section 73, thereby positioning the bundle of sticky notes 2 (see FIG. 8A). Thereafter, using the coil spring, the free-end-side hook section 74 is rotated until it reaches the latch position, and the extra length section 71 on the front side is latched thereby so that the bundle of sticky notes 2 is loaded (see FIG. 8B). As such, the bundle of sticky notes 2 is set to the sticky note holder 31 not to move in the horizontal direction. Herein, the sticky note holder 31 in the state of FIG. 8B may be preferably provided with a stopper for use to restrict the extra length section 71 on the front side. Although not specifically shown, the free-end-side hook section 74 may be made of a material such as rubber, and may be moved to the latch release position in such a way as to be bent.

FIGS. 8C and 8D show the free-end-side hook section 74 being allowed to move to slide in the horizontal direction, i.e., the free-end-side hook section 74 including therein a coil spring (not shown) is attached to the front end portion of the sticky note holder 31 to be able to freely slide in the fore-and-aft direction. If this is the case, the free-end-side hook section 74 is first moved to slide frontward against the force of the coil spring, and then the bundle of sticky notes 2 is positioned to the sticky note holder 31 (see FIG. 8C). Thereafter, a user takes his or her hand off from the free-end-side hook section 74 so that the bundle of sticky notes 2 is put in the loading state (see FIG. 8D). Also in this case, the bundle of sticky notes 2 is latched by both the free-end-side hook section 74 and the adhesive-end-side hook section 73 in the extra length section 71 on the front side, and thus the bundle of sticky notes 2 is never lifted up from the sticky note holder 31.

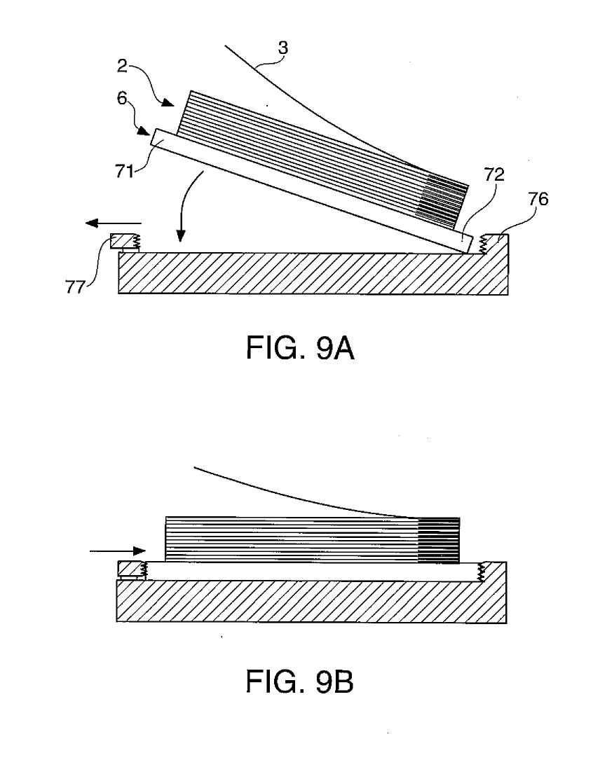

By referring to FIGS. 9A and 9B, described next is the configuration of an area around the sticky note holder 31 in a fourth modified example of the first embodiment. In this fourth modified example, the sticky note holder 31 is formed with an adhesive-end-side abutment section 76, and a free-end-side abutment section 77. The adhesive-end-side abutment section 76 is shaped like a sawtooth for digging into the end surface of the extra length section 72 on the rear side, and the free-end-side abutment section 77 is also shaped like a sawtooth for digging into the end surface of the extra length section 71 on the front side. The adhesive-end-side abutment section 76 is formed at the rear end portion of the sticky note holder 31 to be a piece therewith, and similarly to the free-end-side hook section 74 described above, the free-end-side abutment section 77 is attached to the rear end portion of the sticky note holder 31 to be able to freely slide. Also in this case, the free-end-side abutment section 77 is incorporated with a coil spring (refer to the description above).

That is, the free-end-side abutment section 77 is moved to slide until it reaches the abutment free position, and the side surface of the first extra length section 71 is made to abut the adhesive-end-side abutment section 76. The free-end-side abutment section 77 is then put back to the abutment position so that the adhesive-end-side abutment section 76 digs into the extra length section 72 on the rear side, and the free-end-side abutment section 77 digs into the extra length section 72 on the rear side. As such, the bundle of sticky notes 2 is loaded to the sticky note holder 31 not to move.

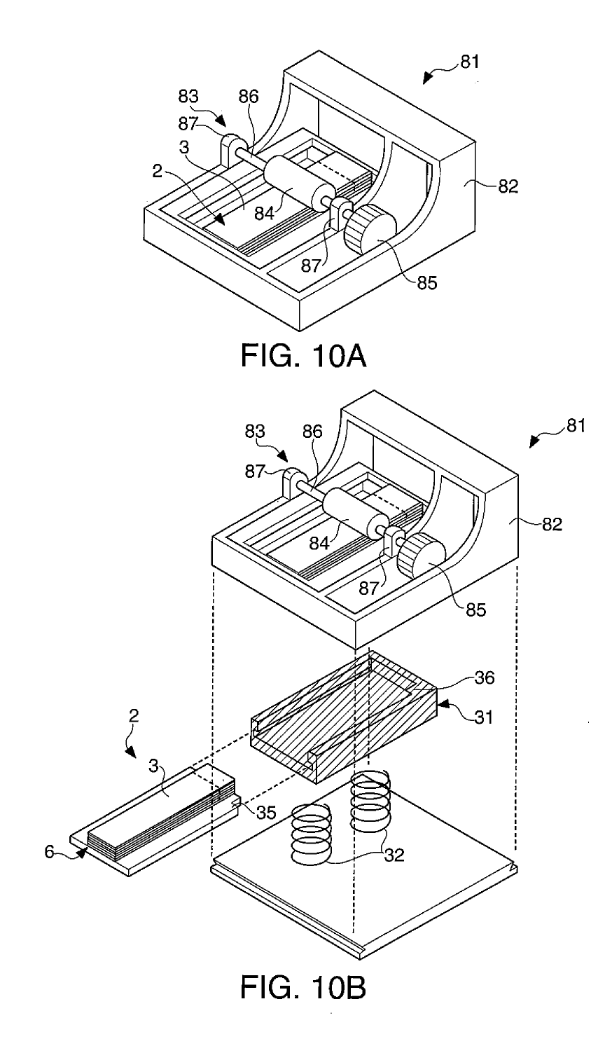

By referring to FIGS. 10A and 10B, described next is a sticky note supply device in a second embodiment of the invention. This device is used by a user to peel off a sticky note from a bundle thereof, and is a so-called sticky note dispenser, i.e., sticky note supply device. Herein, only any difference from the first embodiment is described.

As shown in FIGS. 10A and 10B, a sticky note dispenser 81 is configured to include a case 82, and a sticky note rub-and-pickup mechanism 83. The case 82 is detachably attached with the above-described sticky note cassette 13 from below. The sticky note rub-and-pickup mechanism 83 is disposed at the center of the case 82, and comes in contact from above with the bundle of sticky notes 2 in the attached sticky note cassette 13. The case 82 is an aperture section whose upper side is wide open, and from this portion, a user puts his or her hand to peel off the sticky note 3 from the bundle of sticky notes 2. Note that the sticky note 3 and the sticky note holder 31 in this embodiment use the sticky note holder 31 in the first embodiment.

The sticky note rub-and-pickup mechanism 83 is attached to a part of the case 82 and is disposed opposed to contact with the upper side of the bundle of sticky notes 2, and is configured to include a rub-and-pickup roller 84, a manual operation knob 85, a rotation shaft 86, and a pair of bearing sections 87. The rub-and-pickup roller 84 serves to rub and pick up the sticky note 3 from the bundle of sticky notes 2. The manual operation knob 85 is coaxial to the rub-and-pickup roller 84, and is rotated by a user to make it rub and pick up the sticky note 3, and the rotation shaft 86 is fixed with both the rub-and-pickup roller 84 and the manual operation knob 85. The pair of bearing sections 87 each axially support the rotation shaft 86 to be able to freely rotate.

In the rub-and-pickup roller 84, the rotation surface is made of a material such as rubber, and is coming in contact with the free end side of the bundle of sticky notes 2. In this case, because the sticky note holder 31 loaded with the bundle of sticky notes 2 is biased upward by the coil springs 32, the rub-and-pickup roller 84 is always coming in contact with the bundle of sticky notes 2. As such, when a user rotates the manual operation knob 85, the rub-and-pickup roller 84 coaxial thereto responsively rubs and picks up the sticky note 3 on the top of the bundle of sticky notes 2.

That is, when a user rotates the manual operation knob 85 toward the front, in response thereto, the rub-and-pickup roller 84 is also rotated toward the front. With such a rotation movement of the rub-and-pickup roller 84, the center portion of the sticky note 3 on the top of the bundle of sticky notes 2 is lifted up as if being curved. Immediately after the free end of the lifted-up sticky note 3 passes directly below the rub-and-pickup roller 84, the sticky note 3 is popped up above the rub-and-pickup roller 84 due to the rotation of the rub-and-pickup roller 84 so that the free end portion of the sticky note 3 is positioned on the rub-and-pickup roller 84 due to the rigidity of the sticky note 3. At this timing, the user peels off the sticky note 3.

With such a configuration, the bundle of sticky notes 2 is retained in the sticky note holder 31 via the extra width sections 5, and is kept at the position abutting the rub-and-pickup roller 84 by the sticky note holder 31, the case 82, and the rub-and-pickup roller 84. As such, the sticky note 3 can be peeled off with reliability from the bundle of sticky notes 2 without causing any misalignment of the pile of sticky notes 4.

Note that the bundle of sticky notes 2 for use in the sticky note printer 1 and the sticky note dispenser 81 in this embodiment also has the technical meaning when it is solely used (see FIG. 1). That is, the pair of extra width sections 5 and the front and rear extra length sections 71 and 72 described above each serve as a hand-holding portion when the sticky note 3 is peeled off from the bundle of sticky notes 2, thereby favorably achieving stability for peeling off of the sticky note 3. A user holds such a pair of extra width sections 5 or others to peel off the sticky note 3, and peeling off of the sticky note 3 can be performed with stability thanks to the rigidity of the base member 6 formed thick, and thanks to the pair of extra width sections 5 or others preventing any finger touch to the pile of sticky notes 4. This is especially apparent when the bundle of sticky notes 2 gets low, i.e., when the remaining number of sticky notes 3 becomes less.

What is claimed is:

1. A bundle of sticky notes comprising:
a pile of sticky notes including a plurality of sticky notes whose one end portions are peelably adhered to one another; and
a base member adhered to the pile of sticky notes via the lowermost sticky note, wherein
an outer periphery of the base member partially protrudes from the pile of sticky notes.

2. The bundle of sticky notes according to claim 1, wherein
the pile of sticky notes and the base member are each formed in a rectangular shape in a planar view, and
with respect to the pile of sticky notes, two width-direction sides of the base member protrudes.

3. A sticky note supply device that houses therein a bundle of sticky notes including a pile of sticky notes including a plurality of sticky notes whose one end portions are peelably adhered to one another, and a base member adhered to the pile of sticky notes via the lowermost sticky note, and allows the sticky note to be peeled off from the pile of sticky notes, the device comprising:
a sticky note holder that detachably holds the bundle of sticky notes; and
a chassis that houses therein the sticky note holder, and is provided with an aperture section for peeling off the sticky note, wherein
the sticky note holder includes a base member retention section that holds down the base member against a force of peeling off the sticky note, and
the base member includes a latch section that is latched by the base member retention section in a peel-off direction of the sticky note.

4. A sticky note supply device comprising:
a sticky note holder that detachably holds a bundle of sticky notes including a pile of sticky notes including a plurality of sticky notes whose one end portions are peelably adhered to one another, and a base member adhered to the pile of sticky notes via the lowermost sticky note;
a sticky note peel-off unit that is disposed opposed to the bundle of sticky notes retained by the sticky note holder, and peels off and forwards the sticky note one by one from the sticky note on the top of the pile; and
a chassis that houses therein the sticky note holder and the sticky note peel-off unit, wherein
the sticky note holder includes a base member retention section that holds down the base member against a force of peeling off the sticky note, and
the base member includes a latch section that is latched by the base member retention section in a peel-off direction of the sticky note.

5. The sticky note supply device according to claim 4, further comprising
a cassette that retains the sticky note holder in an upward-biased state, and is detachably inserted into the chassis.

6. The sticky note supply device according to claim 3, wherein
in the base member, two width-direction sides each have an extra width section that is a protrusion from the pile of sticky notes,
the latch section of the base member is configured by the extra width section, and
the base member retention section of the sticky note holder is configured by a dovetail groove formed on a side portion with which each of the extra width sections is slidably engaged and is latched in the peel-off direction.

7. The sticky note supply device according to claim 6, wherein
one of the extra width sections is formed with a cut-out portion as a result of cutting out a tip end portion in a sliding direction, and
the sticky note holder corresponding to the other extra width section is formed with an engagement portion for engagement with the cut-out portion.

8. The sticky note supply device according to claim 3, wherein
in the base member, a side closer to an adhesive section of each of the sticky notes has an extra length section that protrudes from the pile of sticky notes, and an aperture section is formed on a free end side,
the latch section of the base member is configured by the extra length section and the aperture section, and
the base member retention section of the sticky note holder is configured by a dovetail groove formed on the adhesive-end side for latching of the extra length section in the peel-off direction, and a push-in protrusion section into which the aperture section is pushed.

9. The sticky note supply device according to claim 3, wherein
in the base member, a side closer to an adhesive section of each of the sticky notes has an extra length section that is a protrusion from the pile of sticky notes, and a notch section is formed on a free end side,
the latch section of the base member is configured by the extra length section and the notch section, and
the base member retention section of the sticky note holder is configured by a dovetail groove formed on the adhesive-end side for latching of the extra length section in the peel-off direction, and a push-in protrusion section into which the notch section is pushed.

10. The sticky note supply device according to claim 3, wherein
in the base member, a side closer to an adhesive section of each of the sticky notes has a first extra length section that is a protrusion from the pile of sticky notes, and a free end side has a second extra length section that is a protrusion from the pile of sticky notes,
the latch section of the base member is configured by the first and second extra length sections,
the base member retention section of the sticky note holder is configured by an adhesive-end-side hook section by which the first extra length section is lathed in the peel-off direction, and a free-end-side hook section by which the second extra length section is latched in the peel-off direction, and
either the adhesive-end-side hook section or the free-end-side hook section is configured to be able to move between a latch position and a latch release position.

11. The sticky note supply device according to claim 3, wherein
in the base member, a side closer to an adhesive section of each of the sticky notes has a first extra length section that is a protrusion from the pile of sticky notes, and a free end side has a second extra length section that is a protrusion from the pile of sticky notes,
the latch section of the base member is configured by the first and second extra length sections,
the base member retention section of the sticky note holder is configured by an adhesive-end-side sawtooth-like abutment section digging into an end surface of the first extra length section, and a free-end-side sawtooth-like abutment section digging into an end surface of the second extra length section, and
either the adhesive-end-side abutment section or the free-end-side abutment section is configured movable between an abutment position and an abutment free position.
